(19) United States
(12) Patent Application Publication
(10) Pub. No.: US 2009/0318657 A1
(43) Pub. Date: Dec. 24, 2009

(54) Sealing gasket for closure and process for production of closure using the same

(75) Inventors: Toshinori Moriga, Tokyo (JP); Naoki Aoyama, Kanagawa-ken (JP); Hiroei Yokota, Kanagawa-ken (JP)

Correspondence Address: BROWDY AND NEIMARK, P.L.L.C.;624 NINTH STREET, NW, SUITE 300, WASHINGTON, DC, 20001-5303, US

(73) Assignees: Toyo Seikan Kaisha, Ltd, Chiyoda-ku (JP); Japan Crown Cork Co., Ltd, Chiyoda-ku (JP); Nippon Polyuerthane Industry Co., Ltd, Minato-ku (JP)

(21) Appl. No.: 10/580,041

(22) PCT Filed: Mar. 14, 2005
(86) PCT No.: PCT/JP2005/004434

§ 371 Date: May 19, 2006

(30) Foreign Application Priority Data
Mar. 17, 2004 (JP) 2004-075925

(51) Int. Cl. C08G 18/08; C08G 18/32

(52) U.S. Cl. 528/74.5

(57) ABSTRACT

A sealing gasket for closure, made of a polyurethane elastomer obtained by reacting the following (A), (B) and (C):
(A) a polyisocyanate component having an isocyanate group content of 5 to 38% by weight and average 2 to 3 functional groups, obtained by modifying an aliphatic isocyanate and/or an alicyclic isocyanate,
(B) a polyol component having a hydroxyl value of 20 to 350 mgKOH/g and average 2 to 3 functional groups, and
(C) a glycerin fatty acid ester having hydroxyl group(s);
   and a process for producing a closure using such a sealing gasket.

The closure sealing gasket made of a polyurethane elastomer, obtained by the present invention, when used for a closure (e.g. a metal closure of a food container having good sealing properties), is little eluted, is less in swelling with an alcoholic beverage and less in the absorption of the odor of the alcoholic beverage into the closure sealing gasket, and is tough, and causes no yellowing.

### BACKGROUND OF THE INVENTION

1. Field of the Invention

The present invention relates to a sealing gasket for closure, made of a polyurethane elastomer which is less in a swelling in particular with an alcoholic beverage and less in the absorption of the odor of the alcoholic beverage into the sealing gasket; and to a process for producing a closure using such a sealing gasket.

2. Description of the Prior Art

Many sealing gaskets for metal closure are made of a material using a polyvinyl chloride resin as a main component, for the good workability and moldability.

In these metal closure sealing gaskets, the polyvinyl chloride resin contains a plasticizer (typified by dioctyl phthalate) in a large amount and, therefore, there has been a problem that the plasticizer dissolves in the oil and fat, etc. with which the sealing gasket comes in contact. Against this dioctyl phthalate, there is a doubt that it may be an endocrine-disrupting substance. As a countermeasure therefor, a metal closure sealing gasket made of a polyvinyl chloride resin composition containing a derivative of an acyl oxycarboxylate as a plasticizer is described in, for example, JP-A-58-67780.

Also, in recent years, generation of dioxin in combustion of polyvinyl chloride resin for its disposal has become a social problem.

Meanwhile, molded polyurethane elastomers have excellent physical properties, for example, high tensile strength, fatigue resistance, good low-temperature flexibility, and abrasion resistance. Because of these properties, polyurethane elastomers are in use in production of rolls, packings, various machine parts, automobile parts, electronic apparatus parts, etc. Further, polyurethane elastomers are a high polymer material having very high biocompatibility to human body and, therefore, are also in use as a catheter, an artificial blood vessel, an artificial heart, an artificial kidney, etc.

As the process for producing a polyurethane resin, there is generally known, for example, a process of reacting a high-molecular polyhydroxyl compound, a low-molecular polyhydroxyl compound (a chain extender) and an organic polyisocyanate in the presence or absence of a catalyst.

This process is largely classified into two processes. One is a one-shot process of subjecting the above-three components to simultaneous reaction and casting; and the other is a prepolymer process of beforehand reacting a high-molecular polyhydroxyl compound and an organic polyisocyanate to form an isocyanate-terminated urethane prepolymer and then subjecting this prepolymer (as a main material) to a crosslinking reaction with a low-molecular polyhydroxyl compound.

As this prepolymer process for producing a polyurethane resin, there is disclosed, in, for example, JP-A-63-8685, a process which comprises reacting a polyester polyol with diphenylmethane diisocyanate to form an isocyanate-terminated urethane polymer and then subjecting this prepolymer (as a main material) to a heat treatment of 140° C. with a mixture (as a crosslinking agent) of 1,4-butanediol and trimethylolpropane to obtain a polyurethane elastomer having a hardness (JIS A) of 78 to 80. The polyurethane elastomer obtained by this process has excellent mechanical strengths and is well balanced as a cleaning part for electronic photocopier, in particular.

As the technique of using a polyurethane resin as a sealing gasket for a closure of a container (e.g. a pail or an open drum), there is, for example, a technique described in JP-A-61-9481. In this technique, a first solution containing a urethane prepolymer as a main component and a second solution containing a polyol as a main component are mixed to obtain a mixture having a controlled viscosity of 200 to 20,000 mPa·s at 0 to 60° C.

In the above technique disclosed in JP-A-61-9481, as the polyisocyanate compound used for obtaining the urethane prepolymer, there are mentioned tolylene diisocyanate, diphenylmethane diisocyanate, etc. In the Examples of the literature, there is used an isocyanate-terminated prepolymer obtained by reacting tolylene diisocyanate and a bifunctional polypropylene glycol.

Polyurethane elastomers using such an aromatic isocyanate have a long history. In the casting by the prepolymer process, a short-chain glycol such as 1,4-butanediol, trimethylolpropane or the like is used as a curing agent for diphenylmethane diisocyanate-based urethane prepolymer, and an amine compound typified by CUAMINE or MOCA is used as a curing agent for tolylene diisocyanate-based urethane prepolymer. A polyurethane elastomer produced by curing with MOCA has a long history, but MOCA is feared for its possible carcinogenicity.

Polyurethane elastomers using an aromatic isocyanate have excellent mechanical strengths. However, when they are produced so as to have a low hardness, specifically a JIS A hardness of 75 or less, they are extremely inferior in mechanical properties and have had a problem particularly in tensile strength. Further, since aromatic polyisocyanates cause yellowing with the lapse of time, it was impossible to produce a molded polyurethane elastomer causing no yellowing, using an aromatic isocyanate.

Furthermore, when a polyurethane elastomer is used in hygienic storage of food, the aromatic isocyanate used as a component of the polyurethane elastomer is hydrolyzed to become an amine compound. For example, 4,4′-diphenylmethane diisocyanate, when hydrolyzed, becomes 4,4′-diaminodiphenylmethane. This compound is ordinarily called DAM and has a very high carcinogenicity. Therefore, it is not preferred to use an aromatic amine or a compound which may become an amine terminal when hydrolyzed, for production of a polyurethane elastomer used in hygienic storage of food.

In consideration of these points, a sealing gasket for a closure, comprising a polyurethane elastomer, has been proposed, said polyurethane elastomer being low in hardness, causing no yellowing, and being able to be used even for a food hygiene application (See JP-A-2002-193315). The polyurethane elastomer for this sealing gasket is produced by using a polyisocyanate component and a polyol component, said polyisocyanate component having an isocyanate group content of 5 to 38% by weight and an average functional group number of 2 to 3, said polyol component having a hydroxyl value of 20 to 350 mgKOH/g and an average functional group number of 2 to 3. The polyisocyanate component is formed by modifying an aliphatic isocyanate and/or an alicyclic isocyanate.

However, the polyurethane elastomer for this sealing gasket has narrow options in a balance between hydrophobic and hydrophilic properties, and thus it is difficult to ensure a proper balance between hydrophobic and hydrophilic properties, which is very low in an affinity for a lower alcohol (in particular, ethanol). Therefore, there is caused a problem that when the sealing gasket is used for filling an alcoholic beverage, the polyurethane elastomer of a closure is swelled, and the odor of the alcoholic beverage is transferred to the sealing gasket so as to be left therein.

### SUMMARY OF THE INVENTION

An object of the present invention is to provide a sealing gasket for a closure, comprising a polyurethane elastomer, said polyurethane elastomer being less in a swelling with an alcoholic beverage, and in the absorption of the odor of the alcoholic beverage into the sealing gasket; and to provide a process for producing a closure by using the sealing gasket. Furthermore, another object of the present invention is to provide a sealing gasket comprising a polyurethane elastomer, for a closure such as a metallic closure of a food container which is excellent in sealing properties, said polyurethane elastomer being little eluted such that it can be used even for a food hygiene application, being tough and causing no yellowing; and to provide a process for producing a closure by using the sealing gasket.

As a result of a study, the present inventors found out that the above aims can be achieved by forming a polyurethane elastomer of low hardness and no yellowing using a non-aromatic polyisocyanate component, a particular polyol component, and a glycerin fatty acid ester having hydroxyl group(s). The present invention has been completed based on the above finding.

That is, the present invention lies in the following (1) to (3).

(1) A sealing gasket for closure, made of a polyurethane elastomer obtained by reacting the following (A), (B) and (C):

(A) a polyisocyanate component having an isocyanate group content of 5 to 38% by weight and average 2 to 3 functional groups, obtained by modifying an aliphatic isocyanate and/or an alicyclic isocyanate,

(B) a polyol component having a hydroxyl value of 20 to 350 mgKOH/g and average 2 to 3 functional groups, and

(C) a glycerin fatty acid ester having hydroxyl group(s).

(2) A process for producing a closure, which comprises reacting the following (A), (B) and (C) at the inner side of a closure to synthesize a polyurethane elastomer in such a state that the polyurethane elastomer is integrated with the closure:

(A) a polyisocyanate component having an isocyanate group content of 5 to 38% by weight and average 2 to 3 functional groups, obtained by modifying an aliphatic isocyanate and/or an alicyclic isocyanate,

(B) a polyol component having a hydroxyl value of 20 to 350 mgKOH/g and average 2 to 3 functional groups, and

(C) a glycerin fatty acid ester having hydroxyl group(s).

(3) A process for producing a closure, which comprises lining the inner side of a closure with the following (A), (B) and (C), and then reacting the (A), the (B) and the (C) at 150 to 240° C. for 20 to 200 seconds to synthesize a polyurethane elastomer in such a state that the polyurethane elastomer is integrated with the closure:

(A) a polyisocyanate component having an isocyanate group content of 5 to 38% by weight and average 2 to 3 functional groups, obtained by modifying an aliphatic isocyanate and/or an alicyclic isocyanate,

(B) a polyol component having a hydroxyl value of 20 to 350 mgKOH/g and average 2 to 3 functional groups, and

(C) a glycerin fatty acid ester having hydroxyl group(s).

A sealing gasket made of a polyurethane elastomer, obtained in the present invention, when used for a closure (e.g. a metal closure of food container), is less in a swelling with an alcoholic beverage and less in the absorption of the odor of the alcoholic beverage into the sealing gasket, and causes no yellowing by ultraviolet light, has a strength at least equal to those of sealing gaskets produced from an aromatic isocyanate and, moreover, excellent rubber properties, is low in dissolution in liquid foods contained in the food container, and promises sufficient sealability.

The process for producing a closure according to the present invention is high in productivity and can use the production facilities for other materials such as polyvinyl chloride resin and the like.

### DETAILED DESCRIPTION OF THE INVENTION

The present invention is described in detail below.

As the aliphatic isocyanate and alicyclic isocyanate used in the present invention, there can be mentioned hydrogenated aromatic isocyanates, hexamethylene diisocyanate (HDI), isophorone diisocyanate (IPDI), lysine diisocyanate, etc. Of these, HDI and/or IPDI is preferred, and HDI is more preferred.

Polyurethane resins obtained from aromatic polyisocyanates such as tolylene diisocyanate, diphenylmethane diisocyanate and the like are known to cause yellowing and are not ordinarily preferred in applications which come in sight of general consumers. Meanwhile, polyurethane resins obtained from aliphatic isocyanates or alicyclic isocyanates are known not to cause yellowing and are in use in a large amount as an isocyanate source for coating resin. These non-aromatic isocyanates, however, have problems; for example, they have low reactivity and polyurethane elastomers produced therefrom have low tensile strengths. Therefore, the use of the non-aromatic isocyanates has been limited. In the present invention, the above problems have been alleviated by modification of aliphatic isocyanate and/or alicyclic isocyanate.

As the method for modification of aliphatic isocyanate and/or alicyclic isocyanate for production of the polyisocyanate component (A) of the present invention, there can be mentioned, for example, a dimerization reaction (formation of uretdione bond or subsequent formation of carbodiimide bond), a trimerization reaction (formation of isocyanurate bond) or a higher polymerization reaction (formation of uretonimine bond), each of an aliphatic isocyanate and/or an alicyclic isocyanate; a urea-forming reaction, a urethanization reaction or an amidation reaction, each between the above isocyanate and a polyfunctional active hydrogen group-containing compound (e.g. water, polycarboxylic acid, polyol or polyamine); an allophanate-forming reaction or a biuret-forming reaction, each between one of the above reaction products and the above isocyanate; a blocking reaction (masking) between the above isocyanate and a monofunctional active hydrogen group-containing compound (e.g. phenol or monool); and a high polymer-forming reaction or a modification reaction, each between the above isocyanate and a high-molecular polyol having a bond or a substituent (e.g. polyester polyol, polyether polyol or graft polyol). Of these modification methods, preferred are a dimerization reaction, a trimerization reaction, a higher polymerization reaction, a urethanization reaction, a urea-forming reaction, an amidation reaction, an allophanate-forming reaction and a biuret-forming reaction, all using the above isocyanate. Particularly preferred are a dimerization reaction, a trimerization and a urethanization reaction, all using the above isocyanate.

As a specific example of the polyisocyanate component (A), there is preferred a polyisocyanate obtained, as described in JP-B-63-35655, by reacting HDI with a polyol having a number-average molecular weight of 3,000 or less and average 2 to 3 functional groups, to urethanize 15% by weight or less of the total isocyanate groups of HDI to synthesize an HDI-polyol adduct, and then adding, to the HDI-polyol adduct, 0.001 to 0.25% by weight of an isocyanurate-forming catalyst and 0.5% by weight of a co-catalyst to subject 60% by weight or less of the total isocyanate groups to an isocyanurate-forming reaction at 100° C. or less.

Also preferred is, for example, an isocyanate-terminated prepolymer obtained from HDI or IPDI and a low-molecular polyol and/or a high-molecular polyol (in particular, a low-molecular polyol is preferred).

As the low-molecular polyol, there can be mentioned, for example, ethylene glycol, 1,2-propanediol, 1,3-propanediol, 1,2-butanediol, 1,3-butanediol, 1,4-butanediol, 1,5-pentanediol, 1,6-hexanediol, 3-methyl-1,5-pentanediol, neopentyl glycol, 1,8-octanediol, 1,9-nonanediol, diethylene glycol, cyclohexane-1,4-diol, cyclohexane-1,4-dimethanol, dimethylolheptane, dimer acid diol, trimethylolpropane, glycerin, hexanetriol, quadrol, bisphenol A, hydrogenated bisphenol A, compounds having a number-average molecular weight of less than 500, obtained by adding, to one of the above alcohols, ethylene oxide or propylene oxide, and N,N,N′,N′-tetrakis(2-hydroxypropyl)-ethylenediamine, and a mixture of two or more of them.

The high-molecular polyol is a polyol having a number-average molecular weight of 500 or more, preferably 500 to 10,000. As specific examples of the high-molecular polyol, there can be mentioned polypropylene glycol type polyether polyols (PPGs), polytetramethylene ether glycols (PTMGs), adipate type polyester polyols, polycaprolactone type polyester polyols and polycarbonate type polyols, and a mixture of two or more of them, typified by commercial products such as Preminol and Excenol of Asahi Glass Co., Ltd. and ACLAIM of LION DELL, and.

In the present invention, when the polyisocyanate component (A) is produced from HDI, the amount of free HDI in the polyisocyanate component (A) is preferably 1% by weight or less because HDI has a low boiling point, a high vapor pressure and an offensive odor. The polyisocyanate component (A) is preferably a liquid at ordinary temperature for easy handling.

In the present invention, the polyisocyanate component (A) can be used singly or in admixture of two or more kinds.

The isocyanate group content in the polyisocyanate component (A) is 5 to 38% by weight, preferably 8 to 25% by weight. When the isocyanate group content is less than 5% by weight, the polyisocyanate has too high a viscosity and is difficult to handle. When the isocyanate group content is more than 38% by weight, it is substantially difficult to control the concentration of free raw material isocyanate at 1% by weight or less. The “isocyanate group content” referred to herein is the content of isocyanate groups reactive with the polyol component (B), and includes even those isocyanate groups which show no activity of isocyanate group at ordinary temperature but generate isocyanate group at high temperatures, such as hydroxyl-blocked isocyanate group, uretdione group formed by cyclic polymerization of two isocyanate groups, and uretonimine bond formed by addition of one isocyanate group to carbodiimide group. However, the hydroxyl-blocked isocyanate group is not preferred in the present invention because the blocking agent used vaporizes and causes a problem.

The average number of functional groups in the polyisocyanate component (A) is 2 to 3 in view of the compression set and the amount of dissolution of the polyurethane elastomer obtained.

In the present invention, the polyol component (B) is specifically a high-molecular polyol, a low-molecular polyol or a mixture thereof. A high-molecular polyol or a mixture of a high-molecular polyol and a low-molecular polyol is preferred (in particular, a high-molecular polyol is more preferred), because it enables easy achievement of required properties.

In the present invention, each of the high-molecular polyol and the low-molecular polyol can be used singly or in admixture of two or more kinds.

As the high-molecular polyol, there can be mentioned the previously-mentioned polyols having a number-average molecular weight of 500 or more. Of these high-molecular polyols, preferred are PTMGs and adipate type polyester polyols for the low dissolution of the polyurethane elastomer formed therewith. PTMGs preferably have a number-average molecular weight of 500 to 2,000. When the number-average molecular weight is more than 2,000, the PTMG has high crystallinity and is difficult to handle.

As the low-molecular polyol, there can be mentioned the previously-mentioned polyols having a number-average molecular weight of less than 500.

There is no particular restriction as to the amount of the low-molecular weight polyol used. The amount is appropriately determined depending upon, for example, the hardness to be possessed by the intended polyurethane elastomer; however, the amount is preferably 5 moles or less, particularly preferably 0.1 to 3 moles per mole of the high-molecular polyol.

The polyol component (B) has a hydroxyl value of 20 to 350 mgKOH/g, preferably 100 to 350 mgKOH/g. When the hydroxyl value is less than 20 mgKOH/g, the polyurethane elastomer obtained is too soft and has too large a compression set. When the hydroxyl vale is more than 350 mgKOH/g, the polyurethane elastomer obtained is too hard and is unsuitable for use as a sealing gasket. The average number of functional groups of the polyol component (B) is 2 to 3 correspondingly to the average number of functional groups of the polyisocyanate component (A), because the polyurethane elastomer is preferably crosslinked to an appropriate extent.

In the present invention, a glycerin fatty acid ester (C) having hydroxyl group(s) is an ester derived by reacting a glycerin and a fatty acid such that a part of hydroxyl groups in the glycerin are left, that is, the amount of hydroxyl groups in the glycerin are excessive compared to that of carboxyl groups in the fatty acid. Specifically, as a glycerin fatty acid ester (C) having hydroxyl group(s), for example, glycerol monopalmitate, glycerol monostearate, glycerol mono-12-hydroxystearate, glycerol monooleate, glycerol monolaurate, glycerol distearate, glycerol di-12-hydroxystearate, glycerol dioleate, and a mixture of two or more of them can be enumerated.

Among them, a monoglyceride which is produced by esterifying one of three hydroxy-groups in a glycerin with a monofunctional fatty acid is preferred.

In the closure sealing gasket of the present invention, it is possible to use as necessary additives ordinarily used in polyurethane resins, such as catalyst, filler, coloring agent, antioxidant, lubricant, flame retardant, ultraviolet absorber, light stabilizer, electrical insulation improver, fungicide, silicone type surfactant, metal salt of organic acid, wax derived from organic acid, metal oxide, metal hydroxide, internal releasing agent, reinforcing agent, foaming agent and the like.

As the catalyst, there can be mentioned, for example, dibutyltin dilaurate, dioctyltin dilaurate (DOTDL), triethylamine, bismuth 2-ethylhexanoate, diazabicycloundecene, dimethyltin bis(iso-octylglycolate), monomethyltin tris(iso-octylglycolate), di(n-octyl)tin S,S′-bis(iso-octylmercaptoacetate) and di(n-octyl)tin maleate polymer.

The filler is used in order for the molded article obtained to have improved shape retainability, and there can be mentioned a glass fiber, talc, calcium carbonate, calcium oxide, powdery silica, etc.

As the coloring agent, pigments (e.g. titanium oxide) and dyes can be mentioned.

The antioxidant is preferably a hindered phenol type antioxidant. As specific examples, there can be mentioned 3-methyl-2,6-tert-butyl-phenol, tetrakis[methylene-3(3′,5′-di-tert-butyl-4′-hydroxyphenyl)propionate]methane (Irganox 1010 produced by Ciba-Geigy Japan Limited), etc. Irganox 1010 is preferred viewed from the dissolution.

The additives can be added to the polyisocyanate component (A) or to the polyol component (B). However, since some additives react with isocyanate group, addition to the polyol component (B) and/or the glycerin fatty acid ester (C) having hydroxyl group(s) is preferred.

In the present invention, when the polyisocyanate component (A) is reacted with the polyol component (B) and the glycerin fatty acid ester (C) having hydroxyl group(s) to synthesize a polyurethane elastomer, the polyisocyanate component (A) is used in such a proportion that the isocyanate group become preferably 0.9 to 1.5 moles, more preferably about 1.00 to 1.10 moles per mole of the total amount of hydroxyl groups possessed by the polyol component (B) and the glycerin fatty acid ester (C) having hydroxyl group(s).

The loads of a glycerin fatty acid ester (C) having hydroxyl group(s) are preferably 0.1 to 20 parts by weight, and more preferably 0.5 to 10 parts by weight, based on 1,000 parts by weight of a polyol component (B).

In synthesizing the polyurethane elastomer of the present invention, a known urethanization technique can be used. It may be any of a prepolymer process and a one-shot process.

The polyurethane elastomer used in the present invention preferably has a JIS A hardness of 10 to 70, a tensile strength of 1 to 40 MPa and a compression set of 0.1 to 60%. It is an elastomer of low hardness and no yellowing.

When the JIS A hardness of the polyurethane elastomer is less than 10 and when such a polyurethane elastomer is used as a sealing gasket for a closure for container and the closure is applied to a container, the sealing gasket is contacted with the mouth portion of the container too strongly, often making difficult the removal of the closure. When the JIS A hardness of the polyurethane elastomer is larger than 70, the sealing gasket is contacted with the container mouth portion insufficiently (the sealing area is small), often making insufficient the sealing of the container.

When the polyurethane elastomer has a tensile strength of less than 1 MPa, the sealing gasket has an insufficient dynamic strength and is cut off when the closure fitted with the sealing gasket is opened or closed or when the container sealed with the closure is piled up, resulting in impaired sealability. When the polyurethane elastomer has a tensile strength of more than 40 MPa, the contact of the sealing gasket with the container mouth portion is insufficient, resulting in a small sealing area and insufficient sealability.

When the polyurethane elastomer has a compression set of less than 0.1%, the contact of the sealing gasket with the container mouth portion is insufficient, resulting in a small sealing area and insufficient sealability. When the polyurethane elastomer has a compression set of more than 60%, the sealing gasket causes creep owing to the vacuum of the container inside or the pressure applied when the container sealed with the closure is piled up, finally resulting in cutting-off of the sealing gasket along the container mouth.

The polyurethane elastomer used in the closure sealing gasket of the present invention, when subjected to a retort treatment of 120° C.×30 minutes using 10 ml, per g of the polyurethane elastomer, of water, gives an extract showing a potassium permanganate consumption of preferably 30 ppm or less.

In producing a closure (e.g. a metal closure for food container) according to the present invention, specifically and preferably the inner side of the groove of a closure is lined with a premixture of the polyisocyanate component (A), the polyol (B) and the glycerin fatty acid ester (C) having hydroxyl group(s); a reaction is allowed to take place between the component (A) and the component (B) at 150 to 240° C. for 20 to 200 seconds; thereby, a polyurethane elastomer (a sealing gasket) is formed integrally with the closure. When the heating temperature is lower than 150° C., the formation of the polyurethane elastomer is insufficient. When the temperature is higher than 240° C., decomposition of urethane bond may occur. When the heating time is shorter than 20 seconds, the formation of the polyurethane elastomer is insufficient. When the time is longer than 200 seconds, polyurethane elastomer productivity is low and the conventional production line for polyvinyl chloride plastisol is unusable.

In producing a closure (e.g. a metal closure for food container) using a polyurethane elastomer synthesized beforehand, the polyurethane elastomer is melted and extruded into a closure made of a metal, a plastic or the like, or is injected thereinto, to make the polyurethane elastomer integral with the closure. Alternatively, a polyurethane elastomer powder may be placed in a closure and melted to make the polyurethane elastomer integral with the closure. The melting temperature is preferably 150 to 240° C.

In producing a closure of the present invention, (a) the amount of each of a polyisocyanate component (A) and a premixture of a polyol component (B) and a glycerin fatty acid ester (C) having hydroxyl group(s) is determined at a fixed ratio; (b) the quantified polyisocyanate component (A) is homogeneously mixed with the quantified premixture of the polyol component (B) and the glycerin fatty acid ester (C) having hydroxyl group(s); and (c) the homogeneously mixed liquid is intermittently discharged onto the inner surface of a cap so as to line the same.

It is necessary that according to the present invention components for a sealing gasket for a closure be mixed with each other just before the components are fed to the closure. Thus in the lining step, the timing of discharging the mixture in the step (c) mentioned above is preferably interlocked with the timing of feeding the liquid quantified in the step (a) mentioned above to the step (b).

The lining step mentioned above can be suitably carried out by means of a lining apparatus comprising (i) a supporting section for supporting a closure to be lined; (ii) a quantifying section for determining the amount of each of a polyisocyanate component (A) for a lining and a premixture of a polyol component (B) for the lining and a glycerin fatty acid ester (C) having hydroxyl group(s) for the lining, at a fixed ratio; (iii) a mixing section for homogeneously mixing the polyisocyanate component (A) and the premixture of the polyol component (B) and the glycerin fatty acid ester (C) having hydroxyl group(s), as quantified by means of the quantifying section; and (iv) a discharging section for intermittently discharging the liquid homogeneously mixed by means of the mixing section onto the inner surface of the closure as supported by means of the supporting section.

In the lining apparatus above, it is necessary that the individual raw materials for the lining can be precisely weighed in the quantifying section (ii) and be timely discharged to the mixing section (iii), wherein a metering pump such as a Mohno-pump or a gear pump can be suitably used. Furthermore, it is necessary in the mixing section (iii) that both of the liquids be homogeneously mixed with each other so as to prepare a suitable liquid, wherein a static mixing-equipment such as a static mixer, or a forced mixing-equipment such as a homomixer can be suitably used, said static mixing-equipment generating a turbulent flow within a flow channel for mixing the liquids, said forced mixing-equipment forcedly mixing the liquids by applying pressure and/or revolution thereto. Besides, it is significant in the discharging section (iv) that for example, the mixed liquid can be precisely applied in a given amount at a high speed, as well as is excellent in liquid-separating properties, wherein a nozzle gun (a needle valve), a Mohno-pump dispenser, a mixer cartridge or the like can be suitably used. The combination of a Mohno-pump, a static mixer and a nozzle gun (a needle valve) is in particular preferred in the sight of quantifying properties, homogeneous mixing properties, high-speed coating properties, mixed liquid-separating properties, coating-weight stability, film-thickness stability and the like.

The lining apparatus above is preferably provided with a discharge means and/or a modification means, said discharge means automatically discharging a specific quantity of the mixed liquid after a definite period of time in order to prevent the mixed liquid from curing in a flow channel when the apparatus shut down, said modification means automatically modifying the ratio of each of the liquids in the mixing section (iii) and the discharging section (iv) to such a ratio as the liquids are not cured. Furthermore, the lining apparatus is also preferably provided with a cleaning device capable of automatically cleaning itself. Thereby, even when the operation is temporarily stopped, the mixed liquid in the mixing section (iii) can be prevented from curing, and thus the operation can be restarted with no special treatment.

### DESCRIPTION OF THE PREFERRED EMBODIMENTS

The present invention is described in more detail below by way of Examples. However, the present invention should not be construed to be restricted by the Examples.

In the following Synthesis Examples, etc., % refers to % by weight in all cases.

Isocyanate group content was measured by JIS K 7301, and hydroxyl value was measured according to a method specified by JIS K 1601.

The raw materials used in Synthesis examples, etc. are as follows.
HDI: hexamethylene diisocyanate
PTG-1000SN: polytetramethylene ether glycol produced by Hodogaya Chemical Co., Ltd.; hydroxyl value=112 mgKOH/g; average functional group number=2
P-1010: adipate type polyester glycol produced by KURARAY Co., LTD.; hydroxyl value=112 mgKOH/g; average functional group number=2
F-510: adipate type polyestertriol produced by KU Y Co., LTD.; hydroxyl value=336 mgKOH/g; average functional group number=3
RIKEMAL S100: glycerin monostearate; hydroxyl value=313 mgKOH/g; Riken Vitamin Co., Ltd.-make
RIKEMAL OL100 glycerin monooleate; hydroxyl value=315 mgKOH/g; Riken Vitamin Co., Ltd.-make
1,3-BG: 1,3-butanediol
NPG: neo-pentyl glycol
KS-1010A-1: di(n-octyl)tin maleate polymer produced by KYODO CHEMICAL Co., LTD.
Irganox 1010: tetrakis[methylene-3(3′,5′-di-tert-butyl-4′-hydroxyphenyl)-propionate]methane; Ciba-Geigy Ltd.-make

### Synthesis Example 1

Into a reactor were fed 70.7 g of HDI, 7.6 g of 1,3-BG, 6.6 g of neopentyl glycol and 15.2 g of hydrogenated bisphenol A. They were allowed to give rise to a reaction at 70° C. for 5 hours to obtain a viscous liquid having average 2 functional groups and an isocyanate group content of 17.6%. This liquid is named as polyisocyanate A.

### Synthesis Example 2

78.9 g of HDI and 21.1 g of 1,3-BG were fed into a reactor and allowed to give rise to a reaction at 70° C. for 5 hours to obtain a viscous liquid having average 2 functional groups and an isocyanate group content of 19.7%. This liquid is named as polyisocyanate B.

### Examples 1 to 6 and Comparative Examples 1 to 2

### Production of Polyurethane Elastomer Sheets

Individual raw materials beforehand subjected to vacuum degassing were fed into respective filling tanks in an amount ratio shown in Table 1. The raw materials in the tanks were mixed using a metering, discharging and compounding machine (a metering pump was present between each filling tank and the compounding machine) so as to avoid air trapping, whereby a reaction was allowed to take place between the polyisocyanate component, the polyol component and the glycerin fatty acid ester having hydroxyl group(s) at 100° C. for 1 hour to obtain various polyurethane elastomer sheets of 2 mm in thickness, 200 mm in width and 150 mm in length.

Each polyurethane sheet was measured for physical properties. The results are shown in Table 1.

The physical properties were measured according to JIS K 7312. The weather resistance was measured using a sunshine weatherometer and rated by visually examining the appearance after 600 hours.

### [Measurement of Potassium Permanganate Consumption]

15 g of each polyurethane sheet obtained above was immersed in 150 ml of distilled water. They were subjected to a retort treatment at 120° C. for 30 minutes. The aqueous solution (extract) after retort treatment was measured for potassium permanganate consumption (ppm) according to Notification No. 20 of the Welfare Ministry. The results are shown in Table 1.

### [Whiskey Swelling Test]

Approximately 15 g of the polyurethane elastomer sheet mentioned above was immersed in 150 ml of HI Nikka Whisky, followed by treatment at a temperature of 80° C. for three hours. Thereafter, the swelling index of the resultant polyurethane elastomer sheet was determined.

This result was shown in Table 1 together.

[(Weight after Swelling)−(Weight before Swelling)]/(Weight before Swelling)=Swelling Index (%)

### [Whisky Odor Residual Test]

Approximately 15 g of the polyurethane elastomer sheet mentioned above was immersed in a whiskey and water consisting of 15 ml of a HI Nikka Whisky and 135 ml of mineral water Volvic, followed by still standing at room temperature for a period of thirty days.

The odor of the polyurethane elastomer sheet as immersed in the whiskey and water was compared with that of the one as not immersed, by five expert panelists.

This result was shown in Table 1 together.

Evaluation Criteria

◯: With no significant difference in odor; and

x: With a significant difference in odor

TABLE 1

| | | | | | | | Comparative | |
|---|---|---|---|---|---|---|---|---|
| | Examples | | | | | | Examples | |
| | 1 | 2 | 3 | 4 | 5 | 6 | 1 | 2 |
| Polyisocyanate Component (g) | | | | | | | | |
| Polyisocyanate A | | | | 613 | 617 | 621 | | 612 |
| Polyisocyanate B | 548 | 551 | 555 | | | | 547 | |
| Polyol Component (g) | | | | | | | | |
| PTG-1000SN | 667 | 667 | 667 | 667 | 667 | 667 | 667 | 667 |
| P-1010 | 222 | 222 | 222 | 222 | 222 | 222 | 222 | 222 |
| F-510 | 111 | 111 | 111 | 111 | 111 | 111 | 111 | 111 |
| Glycerin Fatty Acid Ester having Hydroxyl | | | | | | | | |
| Group (g) | | | | | | | | |
| RIKEMAL S100 | 1 | 3 | 6 | | | | | |
| RIKEMAL OL100E | | | | 1 | 3 | 6 | | |
| R-value (Equivalent of Isocyanate Group/ | 1.05 | 1.05 | 1.05 | 1.05 | 1.05 | 1.05 | 1.05 | 1.05 |
| Equivalent of Hydroxyl Group) | | | | | | | | |
| Additive Agent (g) | | | | | | | | |
| Catalyst | | | | | | | | |
| KS-1010A-1 | 0.3 | 0.3 | 0.3 | 0.3 | 0.3 | 0.3 | 0.3 | 0.3 |
| Antioxidant | | | | | | | | |
| IRGANOX 1010 | 3 | 3 | 3 | 3 | 3 | 3 | 3 | 3 |
| Properties of Polyurethane Elastomer | | | | | | | | |
| Tensile Strength (MPa) | 14.5 | 14.0 | 14.0 | 14.5 | 14.0 | 14.5 | 14.5 | 15.0 |
| Elongation (%) | 550 | 500 | 500 | 550 | 500 | 500 | 550 | 600 |
| Tear Strength (KN/m) | 27.0 | 27.2 | 27.3 | 27.4 | 26.4 | 24.5 | 26.0 | 27.3 |
| Antiweatherability (after 600 hours) | No | No | No | No | No | No | No | No |
| | Change | Change | Change | Change | Change | Change | Change | Change |
| Consumption of Potassium Permanganate | 1.0 | 0.9 | 1.1 | 1.0 | 1.0 | 0.8 | 1.0 | 1.0 |
| (ppm) | | | | | | | | |
| Whiskey Swelling-Ratio (%) | 10.8 | 9.5 | 8.1 | 11.1 | 9.7 | 8.3 | 26.8 | 28.4 |
| Residual Properties of Whiskey Odor | ∘ | ∘ | ∘ | ∘ | ∘ | ∘ | x | x |

### Example 7

### Production of Closure

The inner side of a groove which had been preformed at the periphery inside a coated metallic closure (a white cap) of a food wide-mouthed bottle was lined with 667 g of PTG-1000SN, 222 g of P-1010, 111 g of F-510, 2 g of REKEMAL S-100, 0.3 g of KS-1010A-1, 3 g of Irganox 1010, 300 g of calcium oxide, 3 g of titanium oxide, and 548 g of polyisocyanate-A by means of a lining apparatus so as to attain a thickness of 1 mm. The resultant closure was immediately positioned in an oven at a temperature of 200° C. for 40 seconds for a reaction so as to obtain a metallic closure for the wide-mouthed bottle, wherein a sealing gasket was monolithically formed.

### [Evaluation of Sealing Gasket]

Hot water of 90° C. was filled in a wide-mouthed bottle by 80% of the internal volume. The bottle was sealed with the above-obtained metal closure and then subjected to a retort treatment at 120° C. for 30 minutes. Thereafter, the bottle was subjected to a stability test of one month at 37° C. The sealability of the bottle was evaluated by the vacuum and vacuum change of the bottle obtained by measuring the internal pressure of the bottle using a vacuum gauge. The vacuum after the stability test was 30 cmHg and was the same as that before the test. The cap was removed after the stability test of one month at 37° C. and the condition of the sealing gasket after the test was examined visually. As a result, there was no abnormality in the condition of the sealing gasket. In an unsuitable sealing gasket, there arises a cut-through phenomenon; that is, cutting-off of sealing gasket takes place along the bottle mouth and the inner surface of the metal closure is exposed.

A polyurethane elastomer sheet was produced in the same manner as in Example 1 and used for measurement of sealing gasket physical properties. The reaction conditions in sheet production were 200° C. and 40 seconds. The sheet showed a tensile strength of 10 MPa, a hardness of 60, an elongation of 400%, a compression set of 6% and a potassium permanganate consumption of 1 ppm. The elastomer showed no discoloration even after 2-month storage.

1. A sealing gasket for closure, made of a polyurethane elastomer obtained by reacting the following (A), (B) and (C):
(A) a polyisocyanate component having an isocyanate group content of 5 to 38% by weight and average 2 to 3 functional groups, obtained by modifying an aliphatic isocyanate and/or an alicyclic isocyanate,
(B) a polyol component having a hydroxyl value of 20 to 350 mgKOH/g and average 2 to 3 functional groups, and
(C) a glycerin fatty acid ester having hydroxyl group(s).

2. A sealing gasket for closure according to claim 1, wherein the (A) is a polyisocyanate component having an isocyanate group content of 5 to 38% by weight and average 2 to 3 functional groups, obtained by modifying an aliphatic isocyanate and/or an alicyclic isocyanate according to a uretdione-forming reaction, an isocyanurate-forming reaction and/or a urethanization reaction.

3. A sealing gasket for closure according to claim 1, wherein the (A) is a polyisocyanate component having an isocyanate group content of 5 to 38% by weight and average 2 to 3 functional groups, obtained by modifying an aliphatic isocyanate and/or an alicyclic isocyanate according to an isocyanurate-forming reaction and/or a urethanization reaction.

4. A sealing gasket for closure according to claim 1, wherein the (B) is a polyol component having a hydroxyl value of 20 to 350 mgKOH/g and average 2 to 3 functional groups, consisting of one or more high-molecular polyol(s).

5. A sealing gasket for closure according to claim 1, wherein the (B) is a polyol component having a hydroxyl value of 20 to 350 mgKOH/g and average 2 to 3 functional groups, consisting of a mixture of a high-molecular polyol and a low-molecular polyol.

6. A sealing gasket for closure according to claim 1, wherein the polyurethane elastomer, when subjected to a retort treatment of 120° C.×30 minutes using 10 ml, per g of the polyurethane elastomer, of water, gives an extract showing a potassium permanganate consumption of 30 ppm or less.

7. A sealing gasket for closure according to claim 1, wherein the polyurethane elastomer has a JIS A hardness of 10 to 70, a tensile strength of 1 to 40 MPa and a compression set of 0.1 to 60%.

8. A process for producing a closure, which comprises reacting the following (A), (B) and (C) at the inner side of a closure to synthesize a polyurethane elastomer in such a state that the polyurethane elastomer is integrated with the closure:
(A) a polyisocyanate component having an isocyanate group content of 5 to 38% by weight and average 2 to 3 functional groups, obtained by modifying an aliphatic isocyanate and/or an alicyclic isocyanate,
(B) a polyol component having a hydroxyl value of 20 to 350 mgKOH/g and average 2 to 3 functional groups, and
(C) a glycerin fatty acid ester having hydroxyl group(s).

9. A process for producing a closure according to claim 8, wherein the (A) is a polyisocyanate component having an isocyanate group content of 5 to 38% by weight and average 2 to 3 functional groups, obtained by modifying an aliphatic isocyanate and/or an alicyclic isocyanate according to a uretdione-forming reaction, an isocyanurate-forming reaction and/or a urethanization reaction.

10. A process for producing a closure according to claim 8, wherein the (A) is a polyisocyanate component having an isocyanate group content of 5 to 38% by weight and average 2 to 3 functional groups, obtained by modifying an aliphatic isocyanate and/or an alicyclic isocyanate according to an isocyanurate-forming reaction and/or a urethanization reaction.

11. A process for producing a closure according to claim 8, wherein the (B) is a polyol component having a hydroxyl value of 20 to 350 mgKOH/g and average 2 to 3 functional groups, consisting of one or more high-molecular polyol(s).

12. A process for producing a closure according to claim 8, wherein the (B) is a polyol component having a hydroxyl value of 20 to 350 mgKOH/g and average 2 to 3 functional groups, consisting of a mixture of a high-molecular polyol and a low-molecular polyol.

13. A process for producing a closure according to claim 8, wherein the polyurethane elastomer, when subjected to a retort treatment of 120° C.×30 minutes using 10 ml, per g of the polyurethane elastomer, of water, gives an extract showing a potassium permanganate consumption of 30 ppm or less.

14. A process for producing a closure according to claim 8, wherein the polyurethane elastomer has a JIS A hardness of 10 to 70, a tensile strength of 1 to 40 MPa and a compression set of 0.1 to 60%.

15. A process for producing a closure, which comprises lining the inner side of a closure with the following (A), (B) and (C) and then reacting the (A), the (B) and the (C) at 150 to 240° C. for 20 to 200 seconds to synthesize a polyurethane elastomer in such a state that the polyurethane elastomer is integrated with the closure:
(A) a polyisocyanate component having an isocyanate group content of 5 to 38% by weight and average 2 to 3 functional groups, obtained by modifying an aliphatic isocyanate and/or an alicyclic isocyanate,
(B) a polyol component having a hydroxyl value of 20 to 350 mgKOH/g and average 2 to 3 functional groups, and
(C) a glycerin fatty acid ester having hydroxyl group(s).

16. A process for producing a closure according to claim 15, wherein the (A) is a polyisocyanate component having an isocyanate group content of 5 to 38% by weight and average 2 to 3 functional groups, obtained by modifying an aliphatic isocyanate and/or an alicyclic isocyanate according to a uretdione-forming reaction, an isocyanurate-forming reaction and/or a urethanization reaction.

17. A process for producing a closure according to claim 15, wherein the (A) is a polyisocyanate component having an isocyanate group content of 5 to 38% by weight and average 2 to 3 functional groups, obtained by modifying an aliphatic isocyanate and/or an alicyclic isocyanate according to an isocyanurate-forming reaction and/or a urethanization reaction.

18. A process for producing a closure according to claim 15, wherein the (B) is a polyol component having a hydroxyl value of 20 to 350 mgKOH/g and average 2 to 3 functional groups, consisting of one or more high-molecular polyol(s).

19. A process for producing a closure according to claim 15, wherein the (B) is a polyol component having a hydroxyl value of 20 to 350 mgKOH/g and average 2 to 3 functional groups, consisting of a mixture of a high-molecular polyol and a low-molecular polyol.

20. A process for producing a closure according to claim 15, wherein the polyurethane elastomer, when subjected to a retort treatment of 120° C.×30 minutes using 10 ml, per g of the polyurethane elastomer, of water, gives an extract showing a potassium permanganate consumption of 30 ppm or less.

21. A process for producing a closure according to claim 15, wherein the polyurethane elastomer has a JIS A hardness of 10 to 70, a tensile strength of 1 to 40 MPa and a compression set of 0.1 to 60%.
